(19) United States
(12) Patent Application Publication
(10) Pub. No.: US 2026/0104034 A1
(43) Pub. Date: Apr. 16, 2026

(54) BEARING ARRANGEMENT AND GEARBOX

(71) Applicants: ZF Friedrichshafen AG, Friedrichshafen (DE); ZF Wind Power Antwerpen N.V., Lommel (BE)

(72) Inventor: Warren SMOOK, Huldenberg (BE)

(21) Appl. No.: 19/354,883

(22) Filed: Oct. 10, 2025

(30) Foreign Application Priority Data
Oct. 14, 2024 (DE) 102024209945.7

(51) Int. Cl. F03D 15/10; F03D 80/70; F16H 57/02; F16H 57/021; F16H 57/08

(52) U.S. Cl. CPC F03D 15/101; F03D 80/70; F16H 57/021; F16H 57/082; F05B 2240/50; F05B 2260/40311; F16H 2057/02078

(57) ABSTRACT

A bearing arrangement for a gearbox has at least one planet carrier, a stationary element, and a bearing. The at least one planet carrier has a first end region and an axially opposite second end region. The first end region is configured to be permanently connected to a shaft for conjoint rotation. The second end region forms a first bearing region, on which the bearing is supported by a radial outer side. The stationary element forms a second bearing region, on which the bearing is supported by a radial inner side.

### CROSS REFERENCE TO RELATED APPLICATIONS

This application claims benefit to German Patent Application No. DE 10 2024 209 945.7, filed on Oct. 14, 2024, which is hereby incorporated by reference herein.

### FIELD

The present disclosure relates to a bearing arrangement for a gearbox having a planetary gearset. The disclosure also relates to a gearbox and to a wind turbine.

### BACKGROUND

Gearboxes may have a planetary gearset to be able to provide a high transmission ratio. For example, such gearboxes are used in wind turbines or hydropower plants, which are used to generate electricity from wind energy and water energy, respectively. An input shaft of the gearbox may be connected to a rotor shaft of such a turbine or plant. During operation, the rotor shaft may deform in an irregular manner owing to active loads. If the input shaft of the gearbox is rigidly connected to the rotor shaft, rotary elements of the gearbox may consequently undergo irregular positional deviations and deformations, as a result of which their respective bearings may be put under high stress. In addition, axial forces may act on the bearings, for example owing to helical toothings in the planetary gearset.

### SUMMARY

In an embodiment, the present disclosure provides a bearing arrangement for a gearbox. The bearing arrangement has at least one planet carrier, a stationary element, and a bearing. The at least one planet carrier has a first end region and an axially opposite second end region. The first end region is configured to be permanently connected to a shaft for conjoint rotation. The second end region forms a first bearing region, on which the bearing is supported by a radial outer side. The stationary element forms a second bearing region, on which the bearing is supported by a radial inner side.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically illustrates a wind turbine comprising a gearbox, according to one or more embodiments of the present disclosure;

FIG. 2 is a schematic sectional side view of a first embodiment of a bearing arrangement for the gearbox of the wind turbine according to FIG. 1, according to one or more embodiments of the present disclosure; and

FIG. 3 is a schematic sectional side view of a second embodiment of a bearing arrangement for the gearbox of the wind turbine according to FIG. 1, according to one or more embodiments of the present disclosure.

### DETAILED DESCRIPTION

A first aspect relates to a bearing arrangement for a gearbox. The gearbox may be configured to transmit torque from a drive to an output. By way of example, the gearbox has at least one planetary gearset. For example, the drive may be formed by a rotary element of the planetary gearset, and the output may be formed by a different rotary element of the planetary gearset. The gearbox may also have a plurality of operatively interconnected planetary gearsets. In that case, for example, a rotary element of a first planetary gearset, such as a planet carrier, an input shaft of the gearbox, and a rotary element of a second planetary gearset may form an output shaft of the gearbox.

By way of example, the gearbox is formed as a gearbox of a wind turbine or a hydropower plant. A turbine or plant of this kind may have a rotor and a generator, for example. The rotor can drive the generator by means of the gearbox in order to generate electrical energy. By way of example, the rotor is connected to the gearbox by means of a rotor shaft. The rotor may have a horizontal or vertical axis of rotation. The rotor may, for example, have two, three, four, or more rotor blades, which are connected to the rotor shaft by means of a hub. The bearing arrangement and thus the gearbox may also form part of a gas turbine or another plant. The gearbox may have a gearbox housing. The gearbox housing may, for example, have one or more housing elements. The gearbox housing may form an inner chamber. By way of example, the drive of the gearbox is mechanically operatively connected to the rotor, and the output of the gearbox is mechanically operatively connected to the generator. The gearbox may be configured to transmit a torque from the rotor shaft to the generator.

The bearing arrangement has at least one planet carrier. The planet carrier may be a rotary element of the planetary gearset of the gearbox. Planetary gearsets are, for example, formed as a negative planetary gearset or a positive planetary gearset. By way of example, planetary gearsets have a sun gear, a planet carrier, and a ring gear. The sun gears, planet carriers, and ring gears of planetary gearsets form the rotary elements thereof, for example. Each planetary gearset may have one or more planet gears which are rotatably fastened to the planet carrier. The planet gears may be borne on the planet carrier by means of planet pins. The planet pins may be formed separately from or integrally with a carrier element. The planet gears may be rotatably borne on the planet pins. Alternatively or additionally, the planet pins may be rotatably borne on the carrier element. By way of example, the planet gears of a planetary gearset each mesh with a sun gear and a ring gear of a planetary gearset. For this purpose, the sun gear, the planet gears, and the ring gear of a planetary gearset may each have a toothing on an external circumference. The toothing may be formed as a straight or helical toothing. An axis of rotation of a planetary gearset may correspond to an axis of rotation of the rotary elements. Relevant planetary gearsets may, for example, be arranged coaxially with the rotor shaft. Each rotary element, the planetary gearset, or even the entire gearbox can be considered to be parts of the bearing arrangement or, with the exception of the planet carrier, to be components separate therefrom. Hereinafter, where the planetary gearset and the planet carrier are mentioned, these should be construed as the planet carrier of the bearing arrangement which forms the first bearing region described below, and the planetary gearset to which this planet carrier belongs.

The bearing arrangement has a stationary element. The stationary element may be part of the gearbox housing and thus form a housing element. By way of example, the stationary element is fixed in place on a foundation or a frame. The stationary element may, for example, be arranged axially between the first planetary gearset and the second planetary gearset of the gearbox, for example on a side of the first planetary gearset that faces away from the drive of the gearbox. The stationary element may be permanently connected to a ring gear for conjoint rotation or may be formed by a stationary ring gear of the gearbox.

The bearing arrangement has a bearing. By way of example, the bearing may support two parts that are rotatable relative to one another, at least at one bearing point. For example, the bearing may have one degree of rotational freedom. The bearing may be configured to bear the planet carrier on the stationary element. The bearing may have one or more bearing elements, such as rolling bearings or sliding bearings.

The planet carrier has a first end region and an axially opposite second end region. The two end regions may be axial end regions of the planet carrier. The two end regions may be arranged on axially opposite sides of planet gears borne on the planet carrier. The planet carrier may be formed in one part or multiple parts. By way of example, the first end region may be formed by a first planet carrier element, and the second end region may be formed by a second planet carrier element. The two planet carrier elements may be permanently interconnected for conjoint rotation, for example by a screw connection.

The first end region is configured to be permanently connected to a shaft for conjoint rotation. For this purpose, the first end region may have a radially external or internal toothing, formed for example as a spline joint. The shaft may have a corresponding toothing, for example on a shaft end region facing the first end region. The connection may be formed, for example, as a press fit, a clearance fit, or a transition fit. By way of example, the flanks of teeth of the toothings of the connection may abut each other even when no torques are applied. Alternatively or additionally, the first end region may be screwable to the shaft, or otherwise connectable or connected thereto. In the case of two rotatable elements permanently connected for conjoint rotation, such as the planet carrier and the shaft, rotation of one element may always cause uniform rotation of the other element. For example, the planet carrier always rotates at the same angular velocity in the same direction as the shaft. The planet carrier and the shaft are arranged coaxially, for example. The shaft may be part of the bearing arrangement. The shaft may be a shaft, such as a rotary element, of the gearbox or a component separate from the gearbox. The shaft may be a drive shaft by which the gearbox can be driven. By way of example, the shaft may be the rotor shaft. The planet carrier may form a drive of the gearbox.

The second end region of the planet carrier forms a first bearing region, on which the bearing is supported by a radial outer side. The second end region may form one or more radially inner circumferential surfaces which the bearing abuts. The stationary forms a second bearing region, on which the bearing is supported by a radial inner side. The stationary component may form one or more radially outer circumferential surfaces which the bearing abuts. These outer circumferential surfaces may be arranged radially internally in relation to further portions of the stationary element. If a plurality of circumferential surfaces are provided, these may be axially adjacent. Owing to this arrangement, the second planet carrier can be borne simply and securely. The bearing may have a small diameter and thus be cost-effective. The bearing may be arranged axially next to the toothings of the planetary gearset. As a result, the active diameter of the toothings can be selected largely irrespective of the bearing. In addition, the bearing may have a large lever arm owing to the bearing point in the opposite direction to the permanent co-rotation connection to the shaft. As a result, forces applied by this shaft can be effectively supported. For instance, the planet carrier is merely tipped slightly and, alternatively or additionally, shifted eccentrically. Therefore, additional loads thus caused in the toothings of the planetary gearset can be low, and so the service life can be high. In addition, an axial length of the bearing arrangement, and thus also of the gearbox, can be low.

The bearing arrangement may have just one bearing. The planet carrier may be borne solely by this bearing. Otherwise, the planet carrier may, for example, be supported solely on the shaft, which is permanently connected to the planet carrier for conjoint rotation at the first end region thereof, and to toothings on other rotary elements. The two bearing regions may form a single bearing point for the planet carrier. The bearing regions may both be arranged in the same axial region. The bearing may be configured to absorb radial forces and optionally also to absorb axial forces.

In one embodiment of the bearing arrangement, it may be provided that the bearing is configured to absorb axial forces. For example, the bearing may be configured to absorb axial forces in both directions. As a result, the bearing can also support axial forces introduced by relevant rotary elements or other planetary gearsets having a helical toothing. Such helical toothings may thus also be used in a simple manner. For example, the bearing may have one or more angular-contact ball bearings or tapered-roller bearings for absorbing axial forces. Alternatively, the bearing may be configured to absorb substantially only radial forces.

In one embodiment of the bearing arrangement, it may be provided that the bearing has two angular rolling bearings, for example two angular-contact ball bearings or tapered-roller bearings. As a result, the bearing can be particularly compact radially and still absorb high loads. This also makes it simple to support axial forces in both directions, for example owing to an arrangement having opposing cants. As a result, the bearing can make good use of axially available installation space.

In one embodiment of the bearing arrangement, it may be provided that the two angular rolling bearings have an X-shaped arrangement. In an X-shaped arrangement, a position of a pressure center may be axially between the two rolling bearings. Alternatively, the two angular rolling bearings may have an O-shaped arrangement. In an O-shaped arrangement, a position of a pressure center may be axially outside the two rolling bearings. The bearing may be a prestressed support bearing. The bearing may be preloaded.

In one embodiment of the bearing arrangement, it may be provided that one of the two rolling bearings is larger than the other of the two rolling bearings. The larger rolling bearing may be configured for higher loads. For example, the larger of the two rolling bearings may have larger rolling members, a larger external diameter, and, alternatively or additionally, a smaller internal diameter. The dimensions that do not result in a larger rolling bearing can all be the same in each case. For example, the two rolling bearings may be asymmetric. A tilt of the rolling bearings may be different. The larger rolling bearing may, for example, be configured to absorb larger loads. A design of this kind may be expedient if, for example, axial loads have to be absorbed by the bearing predominantly in one direction. This is the case, for example, when the gearbox has a helical toothing and is operated solely or predominantly in one direction of rotation. For example, the rotors of wind turbines and hydropower plants typically only ever rotate in one direction, as a result of which the axial forces accordingly only act in one direction too. Owing to the described design, the bearing can then be formed to be optimized for such forces. In the case of rolling bearings of different sizes, one of the two bearing regions or both bearing regions may, for example, be formed in a stepped manner. By way of example, the first bearing region may have a first axial sub-portion and a second axial sub-portion, the first sub-portion having a smaller internal diameter than the second sub-portion.

In one embodiment of the bearing arrangement, it may be provided that the stationary element has a radially extending first wall region. The first wall region may, for example, reach from an outer side of the gearbox to an internal diameter of the bearing. The first wall region may separate an inner chamber into different sub-chambers. The first wall region may be configured to supply lubrication oil, for example to the bearing, the planet carrier, and, alternatively or additionally, the planet gears. By way of example, the first wall region extends along the planet carrier. The first wall region is, for example, axially spaced apart from the second end region of the planet carrier.

A second wall region of the stationary element, which wall region extends axially toward the planet carrier, adjoins the first wall region. The first wall region and the second wall region may be formed in one piece or by different interconnected components. The second wall region may form the second bearing region. The second wall region may also be configured to supply lubrication oil. By way of example, the second wall region may extend axially entirely along the bearing. The second wall region may be arranged radially within the bearing. The second wall region is arranged, for example, axially in the same axial region as the bearing at least in part. The second wall region may extend axially along the entire bearing. The second wall region may be arranged axially in the same region as the first bearing region. The second wall region extends, for example, radially inside in relation to the planet carrier. The second wall region extends, for example, at least radially inside in relation to the second end region of the planet carrier. The second wall region extends, for example, radially inside in relation to the first bearing region.

In one embodiment of the bearing arrangement, it may be provided that the bearing is axially secured. This can reliably prevent the bearing from slipping. In addition, axial forces can be effectively absorbed in this way. The bearing can be axially secured on the stationary element and, alternatively or additionally, on the planet carrier. For example, it is axially secured by stops and, alternatively or additionally, by securing elements such as securing rings, screws, and, alternatively or additionally, washers.

In one embodiment of the bearing arrangement, it may be provided that the bearing arrangement has a sun gear. The sun gear may be the sun gear of the planetary gearset to which the planet carrier also belongs. The sun gear may have a gearwheel element and a shaft element separate therefrom, which are permanently interconnected for conjoint rotation. For example, the gearwheel element and the shaft element are screwed together. The sun gear is, for example, formed in at least two parts. This can improve the ease of assembly. In addition, larger active diameters are simpler to implement in the toothing of the sun gear, despite the fact that the bearing may be arranged radially far internally and the wall portions of the stationary element extend radially far internally.

In one embodiment of the bearing arrangement, it may be provided that the gearwheel element has an external diameter greater than an internal diameter of the stationary element in the second bearing region. As a result, a high transmission ratio can be achieved. In the case of the above-described design of the sun gear in at least two parts, assembly may be simple. The stationary element extends, for example, radially inward beyond an external diameter of the gearwheel element. By way of example, the stationary element may be arranged at an axial offset from the gearwheel element, in particular toward the second end region. The gearwheel element may have an external diameter greater than an internal diameter of the planet carrier in the second bearing region.

A second aspect relates to a gearbox. The gearbox may have the bearing arrangement according to the first aspect, optionally without the shaft. Further features can be taken from the description of the first aspect, with embodiments of the first aspect also constituting embodiments of the second aspect, and vice versa. By way of example, the planet carrier is borne in the gearbox by means of the bearing arrangement.

A further aspect relates to a plant comprising the gearbox according to the first aspect and, alternatively or additionally, the bearing arrangement according to the first aspect. Further features can be taken from the description of the first and second aspects, with embodiments of the first and second aspects also constituting embodiments of the further aspect, and vice versa. The turbine or plant may, for example, be configured to generate electric power. By way of example, the plant may be in the form of a wind turbine, a hydropower plant, or a gas turbine.

The plant may have the shaft, for example in the form of a rotor shaft. The shaft may be permanently connected to the first end region of the planet carrier for conjoint rotation.

### Detailed Description of Embodiments

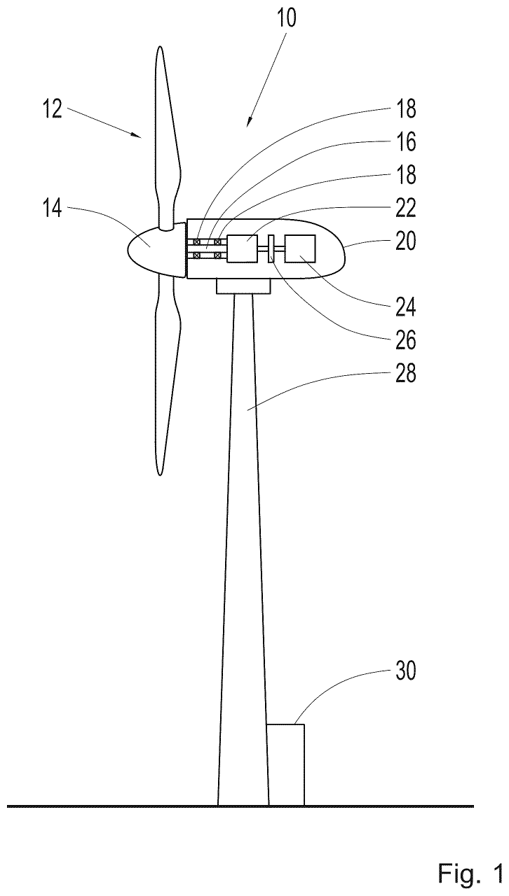

FIG. 1 illustrates a wind turbine 10 in a horizontal design. The wind turbine 10 has a rotor 12, which is held on a rotor shaft 16 by means of a hub 14. The axis of rotation of the rotor shaft 16 extends substantially horizontally. During normal operation, the rotor 12, and thus also the rotor shaft 16, only ever rotate in one direction. The rotor shaft 16 is borne in a nacelle 20 by means of two rolling bearings 18. The rotor shaft 16 is mechanically operatively connected to a generator 24 by means of a gearbox 22. A brake 26 which acts on an input shaft of the generator 24 is arranged in the operative connection between the gearbox 22 and the generator 24. The nacelle 20 is rotatably borne on a top end of a tower 28 anchored to the ground. In a further embodiment, the wind turbine 10 is in the form of an offshore installation. Next to the tower 28, the wind turbine 10 has a grid connection 30.

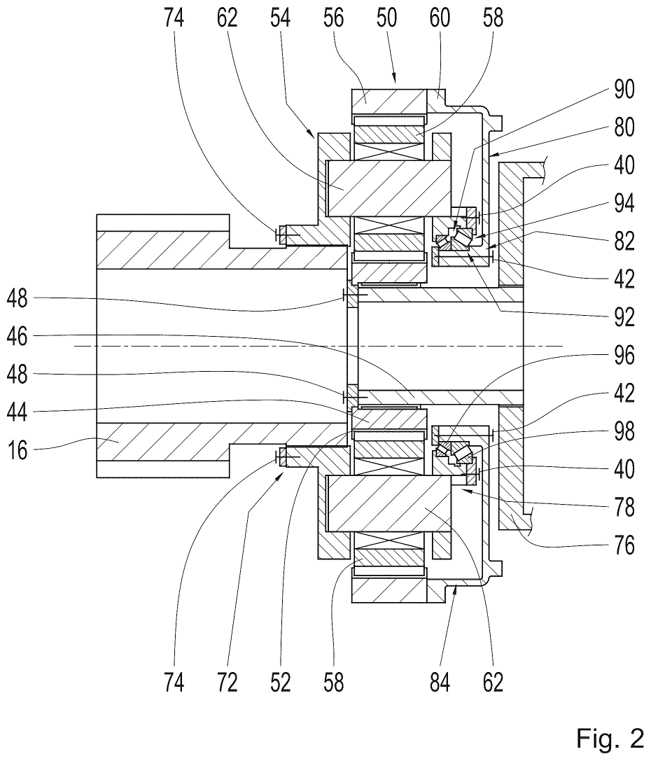

The gearbox 22 has a bearing arrangement, a first embodiment of which is illustrated in FIG. 2. The gearbox 22 has a planetary gearset 50. The planetary gearset 50 has a sun gear 52, a planet carrier 54, and a ring gear 56 as rotary elements. A plurality of planet gears 58 are rotatably borne on the planet carrier 54 by means of respective planet pins 62. The planet gears 58 each mesh with toothings of the ring gear 56 and sun gear 52. The ring gear 56 is fixed in place on a stationary element 60 of the bearing arrangement, which stationary element forms part of a housing of the gearbox 22.

The planet carrier 54 forms part of the bearing arrangement and a drive of the gearbox 22. For this purpose, the planet carrier 54 is permanently connected to the rotor shaft 16, as a further shaft, for conjoint rotation. To do so, a first end region 72 of the planet carrier 54, said end region axially facing the rotor shaft 16 and thus also the rotor 12, forms a spline joint at its radial internal circumference. At an end region axially facing the planet carrier 54, the rotor shaft 16 forms a corresponding spline joint at an external circumference. The rotor shaft 16 and the planet carrier 54 are also secured to one another by a plurality of screws 74.

The sun gear 52 forms an output shaft of the planetary gearset 50 of the gearbox 22. In one embodiment, the sun gear 52 also forms the output of the gearbox 22. In the embodiment shown here, the sun gear 52 is permanently connected to a further planet carrier 76 of a further planetary gearset of the gearbox 22 for conjoint rotation, said further planet carrier being arranged on a side of the planetary gearset 50 facing away from the rotor 12, and thus on a side of the gearbox 22 facing the generator 24. In one embodiment, a further sun gear of said further planetary gearset then forms the output of the gearbox 22.

On a side facing away from the rotor 12, and thus on a side facing the generator 24, the planet carrier 54 forms a first bearing region 90 on a radial internal circumference. The first bearing region 90 is thus formed by a second end region 78 which is axially opposite the first end region 72 and which is arranged on an axially different side in relation to the planet gears 58. The stationary element 60 has a radially extending first wall region 80 which is adjoined by a second wall region 82 extending axially toward the planet carrier 54. The second wall region 82 forms a second bearing region 92 on a radial external circumference.

The first wall region 80 is connected to the ring gear 56 by means of an axially extending third wall region 84 arranged externally to the planet carrier 54. The third wall region 84 forms an outer side of the housing of the gearbox 22.

The bearing arrangement also has a bearing 94 of the gearbox 22. The bearing 94 is supported on the first bearing region 90 by a radial outer side and on the second bearing region 92 by a radial inner side. The bearing 94 is configured to absorb axial forces and radial forces. For this purpose, the bearing 94 has a first angular rolling bearing 96 and a second angular rolling bearing 98. The two angular rolling bearings 96, 98 have an X-shaped arrangement. Axially, the bearing 94 is positioned with respect to the connection of the planet carrier 54 to the rotor shaft 16 in such a way that tipping can be effectively prevented. As a result, additional loads in the toothings of the planetary gearset 50 owing to the rotor shaft 16 warping can be small. Moreover, the bearing 94 is arranged in the gearbox 22 efficiently in terms of installation space.

The second rolling bearing 98 is larger than the first rolling bearing 96. In the embodiment shown, the rolling bearings 96, 98 both have the same internal diameter. Accordingly, the second bearing region 92 is formed as a continuous circumferential surface having a consistent diameter. Each rolling bearing and an external diameter of the second rolling bearing 98 are larger than in the first rolling bearing 96. The first bearing region 90 is accordingly formed in a stepped manner. The bearing 94 is configured to absorb more axial forces toward the second end region 78, and thus toward the generator 24, than toward the first end region 72 and thus toward the rotor 12.

The bearing 94 is axially secured. For this purpose, the first bearing region 90 has a stop in the direction of the first end region 72. In an opposite direction, the bearing 94 is secured by screws 40 and washers. In a variant, the bearing 94 is clamped on the first bearing region 90. In addition, for this purpose the second bearing region 92 has a stop in the direction away from the first end region 72. In the direction toward the first end region 72, the bearing 94 is secured by screws 42 and washers. In a variant, the bearing 94 is clamped on the second bearing region 92. The axial securing allows for simple installation along the axis of rotation of the gearbox 22. In the example shown, the screws 40, 42 are tightened from a direction opposite to the first end region 72.

In the embodiment shown, the sun gear 52 is in a two-part design. The sun gear 52 has a gearwheel element 44 and a shaft element 46 separate therefrom, which are permanently interconnected for conjoint rotation. For this purpose, screws 48 and washers are provided, which can be tightened through the rotor shaft 16, which is formed as a hollow shaft. The gearwheel element 44 has an external diameter greater than an internal diameter of the stationary element 60 in the second wall region 82 and thus in the second bearing region 92. In one embodiment, the bearing 94 is mounted before the gearwheel element 44 is mounted on the shaft element 46.

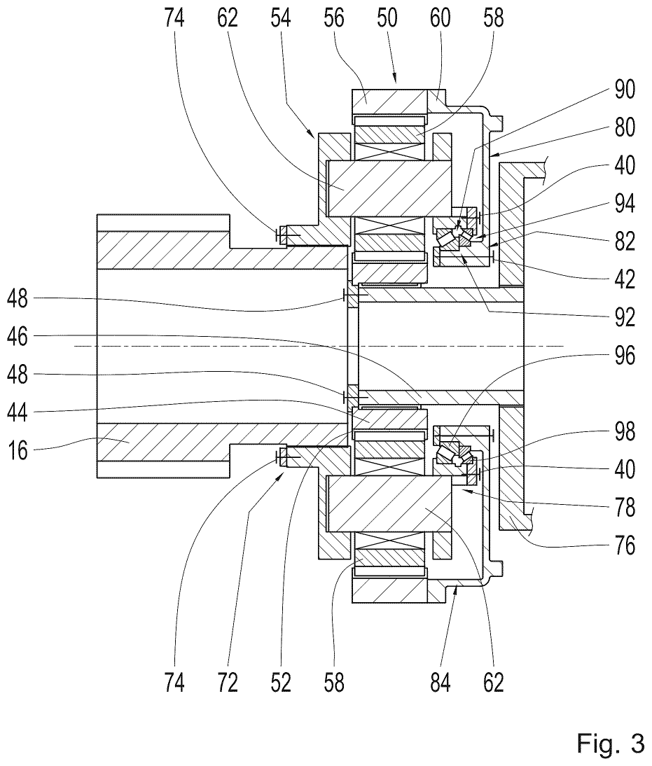

FIG. 3 illustrates a second embodiment of the bearing arrangement of the gearbox 22. Only differences from the first embodiment will be described here. In the second embodiment, the first rolling bearing 96, which axially faces the first end region 72 and thus the rotor 12, is larger than the second rolling bearing 98. In this embodiment of the bearing 94, the two rolling bearings 96, 98 have an identical external diameter. A radial internal circumferential surface forming the first bearing region 90 may be formed to be continuous, in which case a strain-relief notch is provided axially between the two rolling bearings 96, 98. The rolling members of the first rolling bearing 96 is larger, as a result of which an internal diameter is smaller than in the second rolling bearing 98. The second bearing region 92 in the second wall region 82 of the stationary element 60 is thus formed in a stepped manner in the second embodiment. The bearing 94 according to the second embodiment can absorb larger axial forces toward the rotor 12. In the example shown, these are caused by a corresponding helical toothing in the second planetary gearset.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE NUMERALS

10 Wind turbine
12 Rotor
14 Hub
16 Rotor shaft/shaft
18 Rolling bearing
20 Nacelle
22 Gearbox
24 Generator
26 Brake
28 Tower
30 Grid connection
40, 42, 48, 74 Screws
44 Gearwheel element
46 Shaft element
50 Planetary gearset
52 Sun gear
54 Planet carrier
56 Ring gear
58 Planet gears
60 Stationary element
62 Planet pin
72 First end region
76 Further planet carrier
78 Second end region
80 First wall region
82 Second wall region
84 Third wall region
90 First bearing region
92 Second bearing region
94 Bearing
96 First rolling bearing
98 Second rolling bearing

1. A bearing arrangement for a gearbox, comprising:
at least one planet carrier;
a stationary element; and
a bearing,
wherein the at least one planet carrier has a first end region and an axially opposite second end region,
wherein the first end region is configured to be permanently connected to a shaft for conjoint rotation,
wherein the second end region forms a first bearing region, on which the bearing is supported by a radial outer side, and
wherein the stationary element forms a second bearing region, on which the bearing is supported by a radial inner side.

2. The bearing arrangement according to claim 1, wherein the bearing is configured to absorb axial forces.

3. The bearing arrangement according to claim 1, wherein the bearing has two angular rolling bearings.

4. The bearing arrangement according to claim 3, wherein the two angular rolling bearings have an X-shaped arrangement.

5. The bearing arrangement according to claim 3, wherein one of the two angular rolling bearings is larger than other of the two angular rolling bearings.

6. The bearing arrangement according to claim 1, wherein the stationary element has a radially extending first wall region which is adjoined by a second wall region extending axially toward the at least one planet carrier, the second wall region forming the second bearing region.

7. The bearing arrangement according to claim 1, wherein the bearing is axially secured.

8. The bearing arrangement according to claim 1, wherein the bearing arrangement has a sun gear, the sun gear having a gearwheel element and a shaft element separate therefrom, which are permanently interconnected for conjoint rotation.

9. The bearing arrangement according to claim 8, wherein the gearwheel element has an external diameter greater than an internal diameter of the stationary element in the second bearing region.

10. A gearbox comprising a planetary gearset and the bearing arrangement according to claim 1.

11. A wind turbine comprising the gearbox according to claim 10.
